(19) United States
(12) Patent Application Publication
(10) Pub. No.: US 2003/0172913 A1
(43) Pub. Date: Sep. 18, 2003

(54) Intake system for an internal combustion engine

(75) Inventors: Karl-Ernst Hummel, Bietigheim-Bissingen (DE); Stephan Wild, Neuenbuerg (DE)

Correspondence Address: CROWELL & MORING LLP, INTELLECTUAL PROPERTY GROUP, P.O. BOX 14300, WASHINGTON, DC, 20044-4300, US

(73) Assignee: Filterwerk Mann & Hummel GmbH, Ludwigsburg (DE)

(21) Appl. No.: 10/365,614

(22) Filed: Feb. 13, 2003

(30) Foreign Application Priority Data
Feb. 14, 2002 (DE) 102 05 975.6

(51) Int. Cl. F02B 33/00

(52) U.S. Cl. 123/559.1; 123/561

(57) ABSTRACT

An intake system (3) for an internal combustion engine (1) including an engine block (2), as well as an exhaust manifold (7) leading from the engine block (2), the intake system (3) including an intake tract (5) leading to the engine block (2), and having an air filter (4) and a throttle member is arranged in the intake tract (5). The intake system (3) also includes a secondary air system (8) which includes a turbine (10) and a compressor (11). The turbine (10) is subjected to the pressure difference before and after the throttle member in order to drive the compressor (11) which conveys air into the exhaust manifold (7) through a secondary air line (15) to oxidize the exhaust gases at least in the cold start phase of the internal combustion engine. To reduce the number of components and the space required, the compressor (11) and/or the turbine (10) is integrated into a housing (26) of the air filter (4).

### BACKGROUND OF THE INVENTION

The invention relates to an intake arrangement for an internal combustion engine with a secondary air supply system.

Published German Patent Application No. DE 197 13 676 discloses an internal combustion engine with a secondary air system which injects fresh air into the exhaust gas system. A compressor driven by a turbine is provided to convey the fresh air. The turbine is driven by the pressure difference before and after a throttle valve that is arranged in the intake system. With the turbine and the compressor as well as the associated lines, the secondary air system includes several components that must be assembled individually and that require space for installation. In internal combustion engines, however, especially in internal combustion engines for motor vehicles, the available space is often severely limited.

### SUMMARY OF THE INVENTION

It is an object of the invention to provide an improved intake system for an internal combustion engine with a secondary air system.

Another object of the invention is to provide an air intake arrangement with a secondary air system which comprises only a few components and requires little space.

These and other objects are achieved in accordance with the present invention by providing an intake system for an internal combustion engine having an engine block and an exhaust tract leading from the engine block, said intake system comprising an air intake tract leading to the engine block and having an air filter and a throttle member arranged therein, said intake system further comprising a secondary air system comprising a turbine and a compressor, wherein the turbine is subjected to a pressure difference across the throttle member and thereby drives the compressor to convey air through a secondary air line into the exhaust tract at least in a cold start phase of the engine, and wherein at least one of the compressor and the turbine is integrated into a housing of the air filter.

The number of individual components is reduced by integrating the compressor and/or the turbine in a housing of the air filter. The compressor and the turbine do not require a separate air filter, and separate feed lines from an air filter to the compressor and the turbine are eliminated.

Integration into an air filter housing also facilitates optimal acoustic damping. This makes it possible to reduce the generation of noise. The small number of individual components also facilitates assembly.

Particularly in intake systems without a mass flow meter, the turbine is integrated into the housing of the air filter. Thus, the number of individual components upstream of the throttle member can be further reduced. Advantageously, the throttle member is a throttle valve that is arranged in a throttle valve housing. The air intake tract also comprises an intake manifold arranged downstream of the throttle valve.

To reduce the number of separate lines, the bypass line between the turbine outlet and the intake manifold preferably is integrated into the throttle valve housing. Advantageously, the secondary air line can also be integrated into the throttle valve housing. Integrating the secondary air line and the bypass line into the throttle valve housing eliminates the need for separate line sections between the air filter and the intake unit or the exhaust system.

On the downstream side of the compressor, a shutoff valve may be arranged, which is combined with, and preferably integrated into, the compressor so as to form a single component. To control the turbine output, a control valve may be arranged on the turbine and may in particular be integrated into the turbine.

One variant embodiment of the invention provides that the air filter with the compressor, and particularly with the entire secondary air system, be mounted directly to the engine block or to the body of a vehicle driven by the engine.

### BRIEF DESCRIPTION OF THE DRAWING

The invention will be described in further detail hereinafter with reference to illustrative preferred embodiments shown in the accompanying drawings, in which:

FIG. 1 is a schematic illustration of an internal combustion engine with a secondary air charger integrated into the air filter housing;

FIG. 2 is a schematic illustration of an internal combustion engine with a compressor integrated into the air filter housing, and

FIG. 3 is a schematic depiction of an internal combustion engine with valves integrated into the secondary air charger.

### DETAILED DESCRIPTION OF PREFERRED EMBODIMENTS

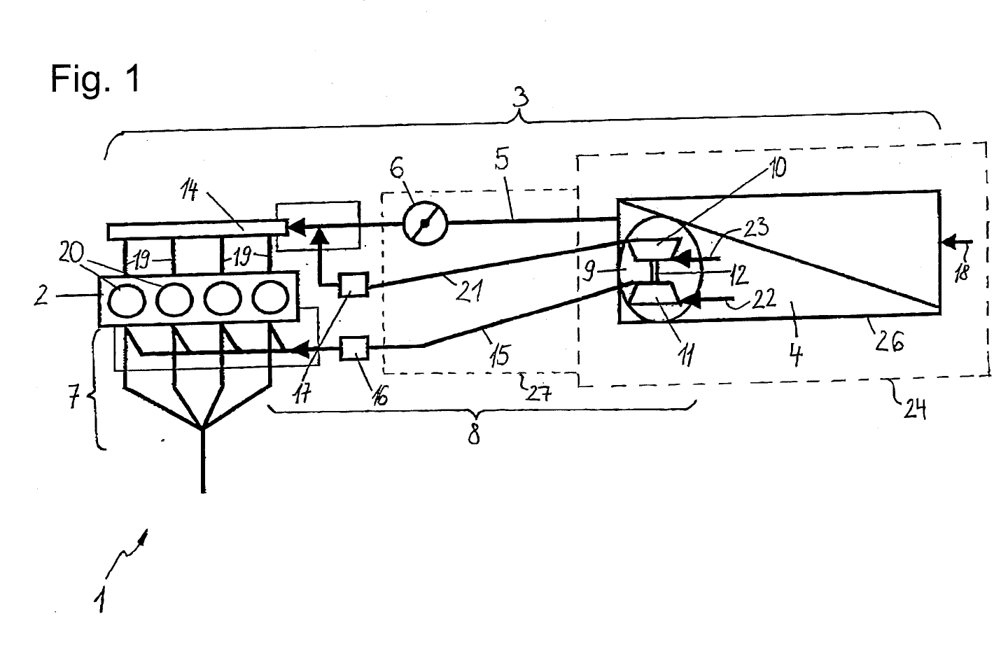

The internal combustion engine 1 depicted in FIG. 1 comprises an engine block 2, which the combustion air reaches through the intake system 3. The exhaust gases leave the engine block 2 through the exhaust system 7. The intake system 3 comprises an air filter 4 inside an air filter housing 26, which the combustion air reaches in the direction indicated by arrow 18. The combustion air is transported through air intake tract 5 into the intake manifold 14.

A throttle element, particularly a throttle valve 6 disposed in a throttle valve housing 27, is arranged in the air intake tract 5. The intake manifold 14 comprises intake pipes 19, each of which opens into a cylinder 20 of the engine block 2.

To decrease the pollutant content of the exhaust gases, particularly in the cold start phase of the internal combustion engine 1, the intake system 3 comprises a secondary air system 8, which introduces fresh air into the exhaust system 7 to oxidize pollutants in the exhaust gases. For this purpose, the secondary air system 8 is provided with a secondary air charger 9.

The secondary air charger 9 comprises a turbine 10 that drives a compressor 11 via a shaft 12. The air flows out of the air filter 4 in the direction indicated by arrow 23 into turbine 10, which is integrated into the air filter housing 26. At the turbine inlet the pressure level is the same as in the air intake tract 5 upstream of the throttle valve 6. From the outlet of turbine 10, a bypass line 21 leads to a section of the air intake tract 5 downstream of the throttle valve 6. The turbine 10 is driven by the pressure difference before and after the throttle valve 6.

A control valve 17 is arranged in the bypass line, which is used to control the air volume flowing through the bypass line 21 and thereby regulate the output of the turbine 10.

From the air filter 4, air also flows in the direction indicated by arrow 22 into the compressor 11. The compressor conveys the air through the secondary air line 15 into the exhaust tract 7. A shutoff valve 16 is arranged in the secondary air line 15, by means of which the supply of secondary air to the exhaust tract can be shut off. It may be advantageous to configure valve 17 as the shutoff valve and/or valve 16 as the control valve, which may in addition be used as a non-return valve.

The secondary air charger 9, which comprises the turbine 10 and the compressor 11, is integrated into the air filter housing 26. The air filter housing 26 and the secondary air charger 9 form a modular unit 24. This module 24 can be mounted directly to the throttle valve housing 27 in which the bypass line 21 and the secondary air line 15 are advantageously integrated.

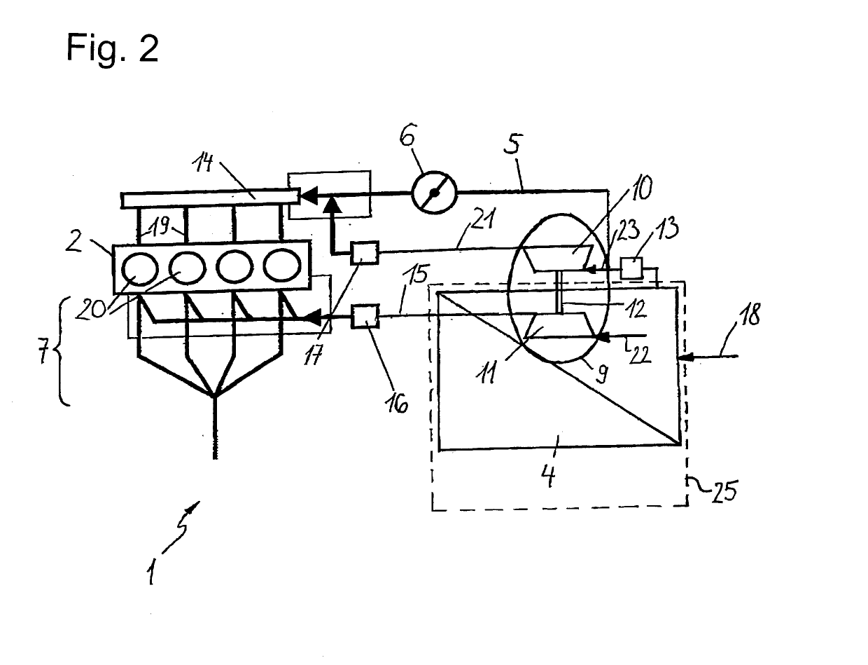

A variant embodiment of the inventive air intake system for an internal combustion engine 1 is schematically illustrated in FIG. 2. Like components are identified by the same reference numerals as those used in FIG. 1. Arranged upstream of the air intake tract 5 and the turbine 10 is a mass flow meter 13, which is configured in particular as a hot film air flow meter and which measures the air volume supplied to the engine block 2.

The compressor 11 is integrated into the air filter 4 and together with the air filter forms module 25. In this embodiment, the mass flow meter 13 and the turbine 10 are not integrated into the air filter 4, but are arranged outside it. Between mass flow meter 13 and turbine 10 the air intake tract 5 branches off to the intake manifold 14. It may also be advantageous, however, to integrate the mass flow meter and the turbine into the air filter, so that the air intake tract 5 exits from the air filter 4 between mass flow meter 13 and turbine 10.

In this embodiment of the invention, the bypass line 21 and the secondary air line 15 can again be integrated into the throttle valve housing. It may also be advantageous to integrate the turbine 10 into the air filter 4 and to arrange the compressor 11 outside the air filter 4.

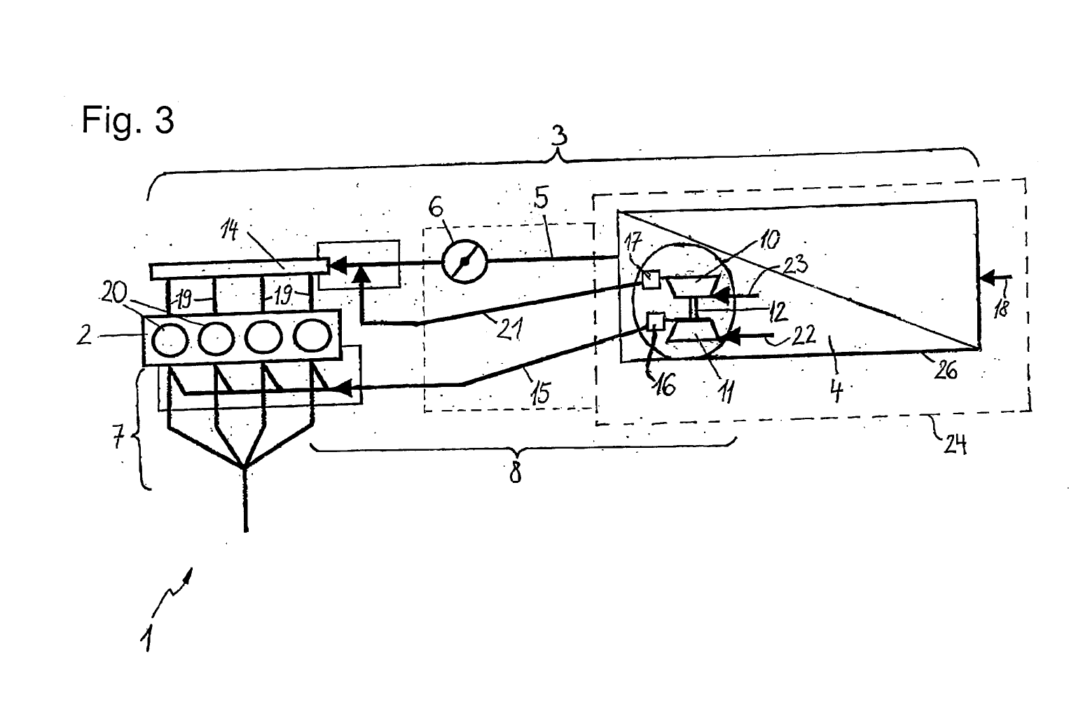

Another embodiment of the invention is schematically illustrated in FIG. 3. The valves 16 and 17 are integrated into the compressor 10 and the turbine 11 and together with the compressor and the turbine form the secondary air charger 9, which is arranged in housing 26 of the air filter 4. The valves 16 and 17 can also be arranged on, or integrated into, the throttle valve housing.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. An intake system for an internal combustion engine having an engine block and an exhaust tract leading from the engine block, said intake system comprising an air intake tract leading to the engine block and having an air filter and a throttle member arranged therein, said intake system further comprising a secondary air system comprising a turbine and a compressor, wherein the turbine is subjected to a pressure difference across the throttle member and thereby drives the compressor to convey air through a secondary air line into the exhaust tract at least in a cold start phase of the engine, and wherein at least one of the compressor and the turbine is integrated into a housing of the air filter.

2. An intake system according to claim 1, wherein the throttle member comprises a throttle valve arranged in a throttle valve housing, and the intake tract comprises an intake manifold arranged downstream of the throttle valve.

3. An intake system according to claim 2, wherein a bypass line between an outlet of the turbine and the intake manifold is integrated into the throttle valve housing.

4. An intake system according to claim 2, wherein the secondary air line is integrated into the throttle valve housing.

5. An intake system according to claim 1, further comprising a secondary air shutoff valve arranged between the compressor and the exhaust tract.

6. An intake system according to claim 5, wherein the shutoff valve is combined with the compressor to form a single component.

7. An intake system according to claim 6, wherein the shutoff valve is integrated into the compressor.

8. An intake system according to claim 1, further comprising a control valve arranged on the turbine.

9. An intake system according to claim 8, wherein the control valve is combined with the turbine to form a single component.

10. An intake system according to claim 9, wherein the control valve is integrated into the turbine.

11. An intake system according to claim 1, wherein the compressor is integrated into the air filter housing, and the air filter housing is mounted directly to the engine block or to the body of a motor vehicle driven by the engine.

12. An intake system according to claim 11, wherein the entire secondary air system is mounted directly to the engine block or to the body of a motor vehicle driven by the engine.
